(19) United States
(12) Patent Application Publication
(10) Pub. No.: US 2025/0150925 A1
(43) Pub. Date: May 8, 2025

(54) ENHANCED CHO/CPC BETWEEN A SOURCE AND TARGET NODE

(71) Applicant: InterDigital Patent Holdings, Inc., Wilmington, DE (US)

(72) Inventors: Oumer Teyeb, Montreal (CA); Martino M. Freda, Laval (CA)

(73) Assignee: InterDigital Patent Holdings, Inc., Wilmington, DE (US)

(21) Appl. No.: 18/837,307

(22) PCT Filed: Feb. 9, 2023
(86) PCT No.: PCT/US2023/012668

§ 371 Date: Aug. 9, 2024

Related U.S. Application Data
(60) Provisional application No. 63/308,413, filed on Feb. 9, 2022.

(51) Int. Cl. H04W 36/36; H04B 17/318; H04W 36/00; H04W 76/20

(52) U.S. Cl. CPC H04W 36/362; H04B 17/328; H04W 36/0058; H04W 36/008357; H04W 76/20

(57) ABSTRACT

Systems, methods, and instrumentalities are described herein for enhanced conditional handover (CHO) ZPSCell change (CPC) between a source and target node having different features/capabilities. Examples of a WTRU configured with CHO/CPC con- figuration information are provided herein. The CHO/CPC configuration information may include a radio resource control (RRC) reconfiguration message (e.g., a delta configuration). If the CHO trigger conditions are fulfilled. the WTRU may execute the RRC reconfiguration message (e.g., the delta configuration) before executing the associated handover (HO) to the target or before executing the associated SCO change.

### CROSS-REFERENCE TO RELATED APPLICATIONS

This application claims the benefit of Provisional U.S. Patent Application No. 63/308,413, filed Feb. 9, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that may be associated with enhanced conditional handover (CHO)/PSCell change (CPC) between a source and target network node (e.g., a source network node and target network node that have or support different features/capabilities).

A WTRU may configured to perform a CHO between a source network node and a target network node. The source node may support one or more features that are not supported by the target network node. For example, the source network node may support a later communications standard version than the target network node, where the later communications standard version may have one or more features not supported by an earlier communications standard version associated with the target network node. The later communications standard version may be a later 3GPP standard Release.

The WTRU may communicate with a source network node in accordance with a first configuration (e.g., the first configuration enabling usage of the feature(s) supported by the source network node, such as, in examples, feature(s) of the later communications standard version). The WTRU may receive CHO configuration information (e.g., associated with a handover (HO) to the target network node). The CHO configuration information may include trigger condition(s), a HO command, and a delta configuration. Based on a determination that the trigger condition(s) are fulfilled, the WTRU may apply the delta configuration. The trigger condition(s) may be fulfilled if at least one of the following occur: a reference signal received power (RSRP) or a reference signal received quality (RSRQ) measurement of the target network node meet a threshold, an RSRP or RSRQ measurement of the source network node meet a threshold, a comparison of RSRP or RSRQ measurements between target network node and the source network node meet a threshold, or a set of radio conditions are fulfilled.

The delta configuration application may change at least a part of the first configuration. For example, the changed first configuration may be compatible with the target network node (e.g., compatible with at least a feature of the target network node, compatible with at least a feature of the earlier version/release compatible with the target network node, etc.). The changed first configuration may be (e.g., continue to be) compatible with feature(s) of the later communications standard version that are not supported by the earlier communications standard version. After applying the delta configuration and before executing the HO command, the WTRU may communicate with the source network node using the changed first configuration (e.g., that allows use of the feature(s) of the later communications standard version). In examples, the delta configuration may change a part of the first configuration to be compatible with a feature of the target network node and not change a part (e.g., a remainder) of the first configuration.

The WTRU may (e.g., after the delta configuration is applied) execute the HO command (e.g., to the target network node). Based on the delta configuration changing at least a part of the first configuration to be compatible with at least a feature of the target network node (e.g., the earlier version/release compatible with the target network node), the HO command may be executed without any version/format issues. In examples, before the HO command is applied and after the delta configuration is applied, the WTRU may communicate with the source network node using the first configuration (e.g., the source network node is compatible with the first WTRU configuration and not compatible with the second WTRU configuration). The delta configuration may provide the WTRU with the ability to communicate with the source network node until the HO command is applied while (e.g., while also) providing the WTRU the ability to execute the HO to the target network node without any version/format issues. The WTRU may send an indication that indicates the HO command and the delta configuration have been applied. The indication may be indicated via a radio resource control (RRC) reconfiguration complete message embedded in an HO complete message sent towards a target network node.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a handover scenario.

FIG. 3 illustrates an example of CHO configuration and execution.

FIG. 4 illustrates an example of a WTRU receiving a CHO configuration.

FIG. 5 illustrates an example of a WTRU configured with a CHO configuration towards two targets.

### DETAILED DESCRIPTION

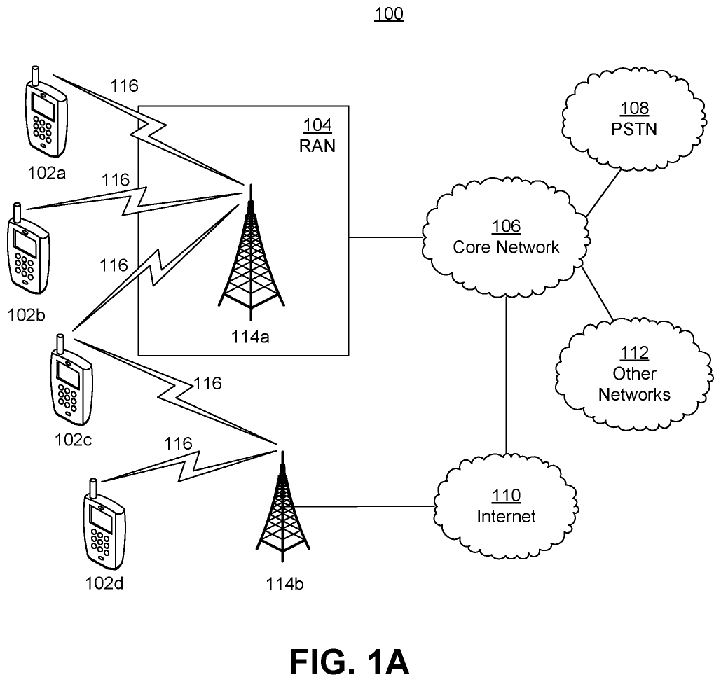

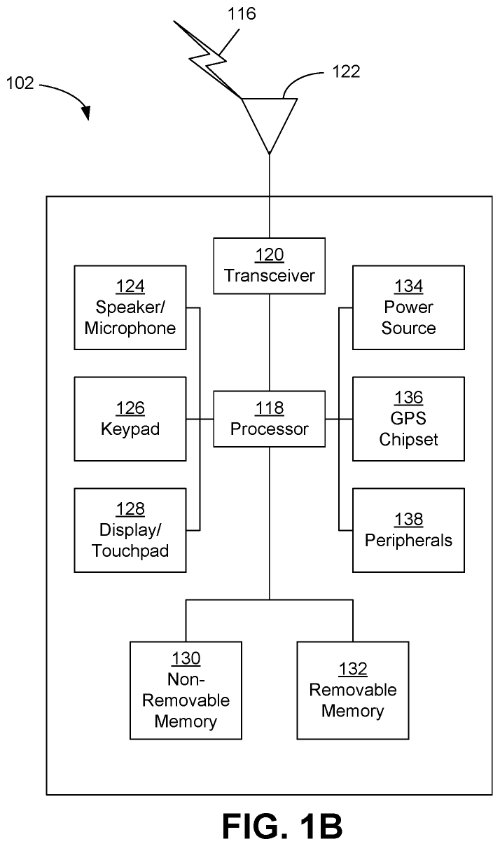

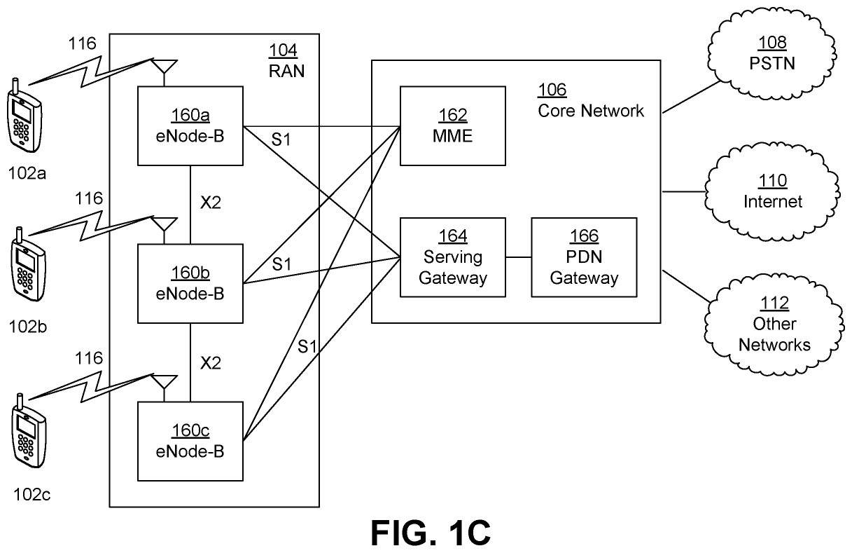

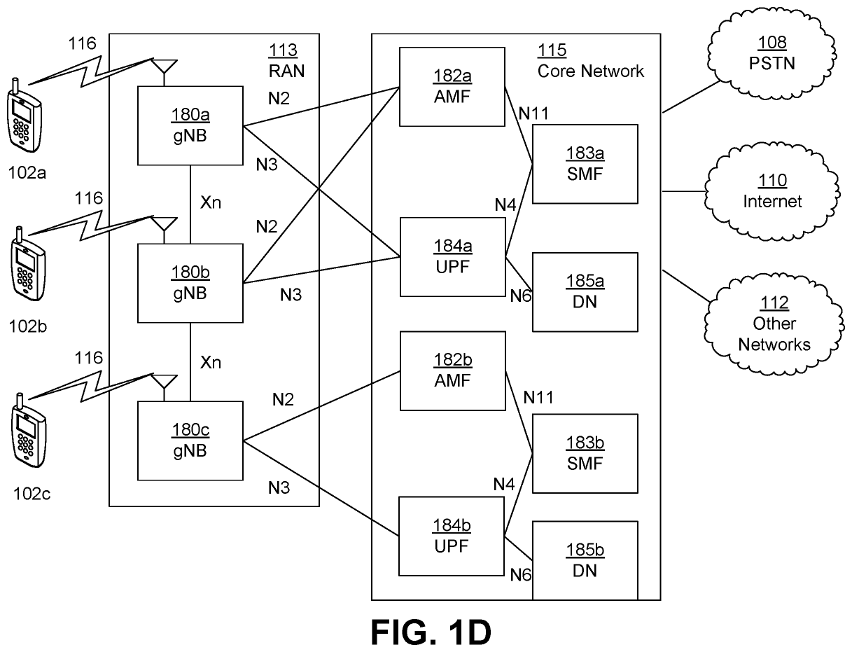

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a timer expiration herein may refer to determining that the time has occurred or that the period of time has expired. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein that may be associated with enhanced conditional handover (CHO)/PSCell change (CPC) between a source and target network node (e.g., a source network node and target network node that have or support different features/capabilities).

A WTRU may configured to perform a CHO between a source network node and a target network node. The source node may support one or more features that are not supported by the target network node. For example, the source network node may support a later communications standard version than the target network node, where the later communications standard version may have one or more features or capabilities not supported by an earlier communications standard version associated with the target network node. The later communications standard version may be a later 3GPP standard Release. For example, the source network node and the target network node may support the same communications standards versions (e.g., 3GPP standard releases), but the source network node may support more features or capabilities than the target network node.

The WTRU may communicate with a source network node in accordance with a first configuration (e.g., the first configuration enabling usage of the feature(s) supported by the source network node, such as, in examples, feature(s) of the later communications standard version). The WTRU may receive CHO configuration information (e.g., associated with a handover (HO) to the target network node). The CHO configuration information may include trigger condition(s), a HO command, and a delta configuration. Based on a determination that the trigger condition(s) are fulfilled, the WTRU may apply the delta configuration. The trigger condition(s) may be fulfilled if at least one of the following occur: an RSRP or RSRQ measurement of the target network node meet a threshold, a reference signal received power (RSRP) or a reference signal received quality (RSRQ) measurement of the source network node meet a threshold, a comparison of RSRP or RSRQ measurements between target network node and the source network node meet a threshold, or a set of radio conditions are fulfilled.

The delta configuration application may change at least a part of the first configuration. For example, the changed first configuration may be compatible with the target network node (e.g., compatible with at least a feature of the target network node, compatible with at least a feature of the earlier version/release compatible with the target network node, etc.). The changed first configuration may be (e.g., continue to be) compatible with feature(s) of the later communications standard version that are not supported by the earlier communications standard version. After applying the delta configuration and before executing the HO command, the WTRU may communicate with the source network node using the changed first configuration (e.g., that allows use of the feature(s) of the later communications standard version). In examples, the delta configuration may change a part of the first configuration to be compatible with a feature of the target network node and not change a part (e.g., a remainder) of the first configuration.

The WTRU may (e.g., after the delta configuration is applied) execute the HO command (e.g., to the target network node). Based on the delta configuration changing at least a part of the first configuration to be compatible with at least a feature of the target network node (e.g., the earlier version/release compatible with the target network node), the HO command may be executed without any version/format issues. In examples, before the HO command is applied and after the delta configuration is applied, the WTRU may communicate with the source network node using the first configuration (e.g., the source network node may be compatible with the first configuration and not compatible with a second configuration). The delta configuration may provide the WTRU with the ability to communicate with the source network node until the HO command is applied while (e.g., while also) providing the WTRU the ability to execute the HO to the target network node associated with a second configuration without any version/format issues. The WTRU may send an indication that indicates the HO command and the delta configuration have been applied. The indication may be indicated via a RRC reconfiguration complete message embedded in an HO complete message sent towards a target network node.

Examples of a WTRU configured with CHO configuration information are provided herein. The CHO configuration information may include a radio resource control (RRC) reconfiguration message (e.g., an additional RRC reconfiguration message). If CHO trigger condition(s) are fulfilled, the WTRU may execute the RRC reconfiguration message (e.g., the additional RRC reconfiguration message) before executing the associated HO to the target network node. Examples of a WTRU configured with CPC configuration information are provided herein. The CPC configuration information may include an RRC reconfiguration message (e.g., an additional RRC reconfiguration message). If CPC trigger condition(s) are fulfilled, the WTRU may execute the RRC reconfiguration message (e.g., the additional RRC reconfiguration message) before executing the associated SCG change.

Examples of a WTRU configured with a legacy CHO configuration and an enhanced CHO configuration applied towards different target network nodes (e.g., a first target and a second target network node) are provided herein. A legacy CHO configuration may be applied towards a first target network node and an enhanced CHO configuration may be applied towards a second target network node. If the WTRU determines that trigger condition(s) are fulfilled (e.g., are fulfilled for the legacy CHO configuration and the enhanced CHO configuration), the WTRU may prioritize applying the legacy CHO configuration over the enhanced CHO configuration. If the trigger condition(s) of the enhanced) CHO configuration information are fulfilled, the WTRU may use a security context associated with a source network node and the second target network node if executing an RRC reconfiguration message (e.g., an additional RRC reconfiguration message). If the trigger condition(s) of the legacy CHO configuration information are fulfilled, the WTRU may use a security context associated with the first target network node.

A WTRU may be configured with CHO configuration information that includes an RRC reconfiguration (e.g., an extra RRC reconfiguration or a delta configuration) that is executed prior to the execution of the handover (HO) to a target network node. This may align the WTRU context to a version compatible with the target network node.

A WTRU connected to a source cell (e.g., source network node) may receive CHO configuration information associated with an HO to a target network node. The CHO configuration information may include trigger condition(s) (e.g., RSRP/RSRQ thresholds concerning the target network node, the source network node, or a comparison between the source network node and the target network node), a first RRC reconfiguration message (e.g., a delta configuration), and/or a second RRC reconfiguration message (e.g., an HO command to the target). The WTRU may monitor the fulfilment of the trigger condition(s) (e.g., compare measurements of serving/neighbor cells with the configured thresholds). In examples, the trigger condition(s) may be fulfilled if at least one of the following occur: an RSRP or RSRQ measurement of the target network node meet a threshold, an RSRP or RSRQ measurement of the source network node meet a threshold, a comparison between measurements (e.g., RSRP or RSRQ measurements) of the target network node and measurements (e.g., RSRP or RSPQ measurements) of the source network node meet a threshold, or a set of radio conditions are fulfilled. If the trigger conditions are fulfilled, the WTRU may execute the first RRC reconfiguration message (e.g., the delta configuration). The WTRU may execute the second RRC reconfiguration message (e.g., the HO command to the target) (e.g., after the successful execution of the first RRC reconfiguration). The WTRU may perform an UL sync (e.g., via random access procedure) towards the target network node. The WTRU may send at least one RRC reconfiguration complete (e.g., an HO complete) message (e.g., indication) to the target network node signifying that the CHO was executed and/or that the first RRC reconfiguration message (e.g., the delta configuration) was executed. The RRC reconfiguration complete indication may be sent via one or more of the following: sending the RRC configuration message directly to the source network node before/during executing the HO command; or by embedding the RRC configuration message in the HO complete message toward the target network node (e.g., the RRC complete reconfiguration message included in a transparent container, a flag, e.g., in a Boolean field, in the HO complete message, etc.)

A WTRU connected to a source cell (e.g., source network node) may receive multiple CHO configurations associated with HOs to different target network nodes (e.g., receive configuration information for a respective CHO configuration to a respective target network node). The CHO configuration to a particular target network node may include a first CHO configuration (e.g., trigger condition(s), and associated HO command) and/or a second CHO configuration (e.g., trigger condition(s), first RRC reconfiguration message, second RRC reconfiguration message, e.g., HO command). The WTRU may monitor the fulfilment of the trigger condition(s) for the CHO configuration(s) (e.g., for all of the CHO configurations to the different target network nodes). If the trigger condition(s) for CHO configuration(s) (e.g., two CHO configurations) are determined to be fulfilled, where a first CHO configuration may be a legacy configuration and a second CHO configuration may be an enhanced CHO configuration, the WTRU may prioritize the first CHO configuration (e.g., the WTRU may execute the HO command associated with the first CHO configuration). If the trigger condition(s) for CHO configuration(s) (e.g., two CHO configurations) are determined to be fulfilled, where a first CHO configuration may be a legacy configuration and a second CHO configuration may be an enhanced CHO configuration, the WTRU may perform one or more of the following: a UL sync (e.g., via random access procedure) towards the first target network node; or send an RRC reconfiguration complete (e.g., HO complete) message to the target network node signifying the CHO was executed, e.g., properly.

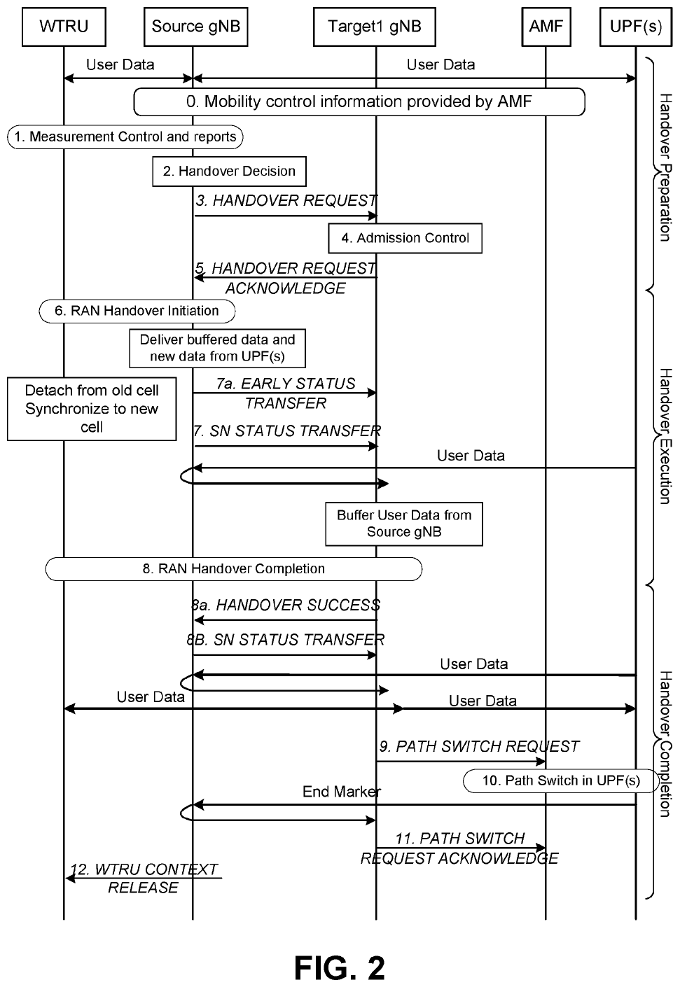

FIG. 2 illustrates an example of an HO scenario (e.g., a basic HO scenario).

At 0, the WTRU context within the source network node (e.g., source gNB) may include information regarding roaming and access restrictions which were provided either at connection establishment or at the last Timing Advance (TA) update.

At 1, the source gNB may configure the WTRU measurement procedures and the WTRU reports according to the measurement configuration.

At 2, the source gNB may decide to HO to the WTRU, based on the received measurements.

At 3, the source gNB may issue an HO request message to the target network node (e.g., target gNB) passing a transparent RRC container with information (e.g., necessary information) to prepare the HO at the target side. The information may include at least: the target cell ID, KgNB*, the C-RNTI of the WTRU in the source gNB, an RRM-configuration including WTRU inactive time, basic AS-configuration including antenna information and DL carrier frequency, the current QoS flow to DRB mapping rules applied to the WTRU, the SIB1 from source gNB, the WTRU capabilities for different RATs, packet data unit (PDU) session related information, and the WTRU reported measurement information including beam-related information (e.g., if available).

At 4, admission control may be performed by the target gNB.

At 5, if the WTRU can be admitted, the target gNB may prepare the HO with L1/L2. The WTRU may send the HANDOVER REQUEST ACKNOWLEDGE to the source gNB. The HANDOVER REQUEST ACKNOWLEDGE may include a transparent container to be sent to the WTRU as an RRC message to perform the HO.

At 6, the source gNB may trigger the Uu handover by sending an RRCReconfiguration message to the WTRU including the information (e.g., required information) to access the target cell (e.g., network node). The information may include at least one of: the target cell ID, the new C-RNTI, or the target gNB security algorithm identifiers for the selected security algorithms. The information may (e.g., may also) include at least one of: a set of dedicated RACH resources, the association between RACH resources and SSB(s), the association between RACH resources and WTRU-specific CSI-RS configuration(s), common RACH resources, or system information of the target cell, etc.

At 7, the source gNB may send the SN STATUS TRANSFER message to the target gNB to convey the uplink PDCP SN receiver status and the downlink PDCP SN transmitter status of DRBs for which PDCP status preservation applies (e.g., for RLC AM).

At 8, the WTRU may synchronize to the target cell. The WTRU may complete the RRC HO procedure by sending RRCReconfigurationComplete message to the target gNB.

At 9, the target gNB may send a PATH SWITCH REQUEST message to an access and mobility management function (AMF). The PATH SWITCH REQUEST may trigger 5GC to switch the DL data path towards the target gNB. THE PATH SWITCH REQUEST may (e.g., may also) establish an NG-C interface instance towards the target gNB.

At 10, the 5GC may switch the DL data path towards the target gNB. The UPF may send one or more “end marker” packets on a path (e.g., on the old path) to the source gNB per PDU session/tunnel. The UPF may (e.g., may then) release any U-plane/TNL resources towards the source gNB.

At 11, the AMF may confirm the PATH SWITCH REQUEST message with a PATH SWITCH REQUEST ACKNOWLEDGE message.

At 12, if receiving the PATH SWITCH REQUEST ACKNOWLEDGE message from the AMF, the target gNB may send a WTRU CONTEXT RELEASE to inform the source gNB about the success of the HO. The source gNB may (e.g., may then) release radio and C-plane related resources associated to the WTRU context. Any ongoing data forwarding may continue.

Examples of conditional HO and CPC are provided herein, which may be applicable to NR. The concepts of CHO and conditional PSCell Addition/Change (CPA/CPC, or collectively referred to as CPAC) may help reduce the likelihood of radio link failures (RLF) and handover failures (HOF).

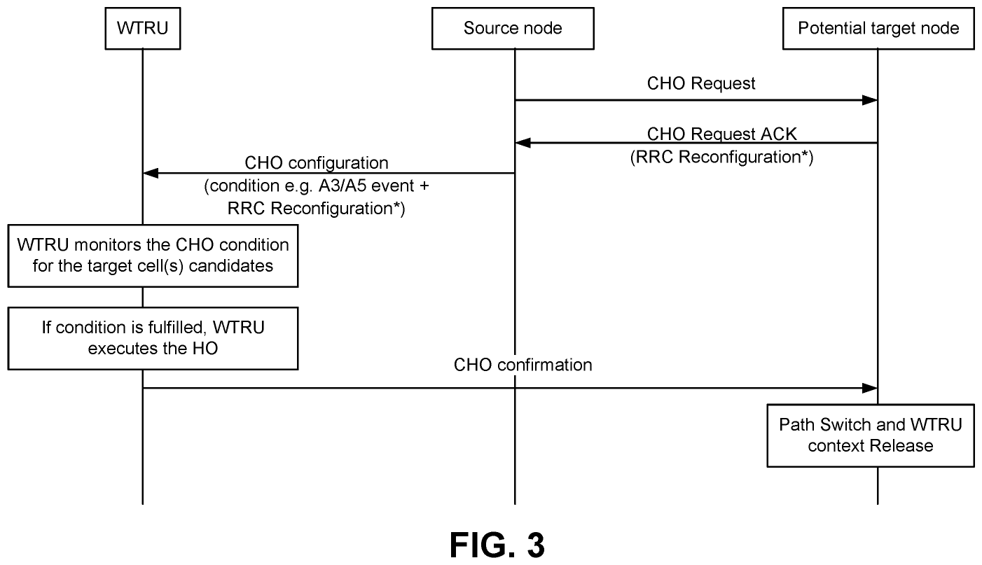

FIG. 3 illustrates an example of CHO configuration and execution. HOs (e.g., legacy LTE/NR HO) may be triggered by measurement reports, even though there may be nothing preventing the network from sending an HO command to the WTRU (e.g., even without receiving a measurement report). The WTRU may be configured with an A3 event. The A3 event may trigger a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). The WTRU may monitor the serving and neighbor cells. The WTRU may send a measurement report if the condition(s) get fulfilled. If such a report is received, the network (e.g., current serving node/cell) may prepare the HO command (e.g., an RRC Reconfiguration message, with a reconfigurationWithSync). The network may send the HO command to the WTRU. The WTRU may execute the HO command (e.g., immediately execute the HO command), which may result in the WTRU connecting to the target cell (e.g., target network node).

CHO feature(s) may include preparation of multiple handover target network nodes (e.g., as compared to one in other HO cases). In CHO, the WTRU may not (e.g., may not immediately) execute the CHO as in other HO cases. Instead, the WTRU may be configured with trigger condition(s) that are related to a set of radio conditions. The WTRU may execute the HO towards one of the target network nodes if (e.g., only if) the triggering condition(s) are fulfilled.

The CHO command may be sent if the radio conditions towards the current serving cells are favorable (e.g., are still favorable). This may reduce the risk of failing to send the measurement report (e.g., if the link quality to the current serving cell falls below acceptable levels when the measurement reports are triggered in normal HO) and may reduce the risk of failing to receive the HO command (e.g., if the link quality to the current serving cell falls below acceptable levels after the WTRU has sent the measurement report, but before it has received the HO command).

The trigger condition(s) for a CHO may (e.g., may also) be based on the radio quality of the serving cells and neighbor cells (e.g., like the conditions that are used in other cases to trigger measurement reports). The WTRU may be configured with a CHO that has A3 like trigger condition(s) and an associated HO command. The WTRU may monitor the current and serving cells. If the A3 trigger condition(s) are fulfilled, instead of sending a measurement report, the WTRU may execute the associated HO command and switch its connection towards the target cell (e.g., target network node).

CHO may help prevent unnecessary re-establishments in case of a radio link failure. In examples, the WTRU may be assumed to be configured with multiple CHO targets and the WTRU may be assumed to experience an RLF before the trigger condition(s) (e.g., with any) of the target network nodes gets fulfilled. Other cases (e.g., a legacy operation) may have resulted in an RRC re-establishment procedure that may have incurred considerable interruption time for the bearers of the WTRU. In examples of CHO, if the WTRU, after detecting a radio link failure (RLF), ends up detecting a cell (e.g., network node) for which it has a CHO already configured (e.g., the target cell is already prepared for it), the WTRU may execute the HO command associated with this target cell (e.g., target network node) directly (e.g., instead of continuing with the full re-establishment procedure).

CPC and CPA may be extensions of CHO (e.g., in DC scenarios). A WTRU may be configured with trigger condition(s) for a PSCell change or addition. If the trigger condition(s) are fulfilled, the WTRU may execute the associated PSCell change or PSCell add commands.

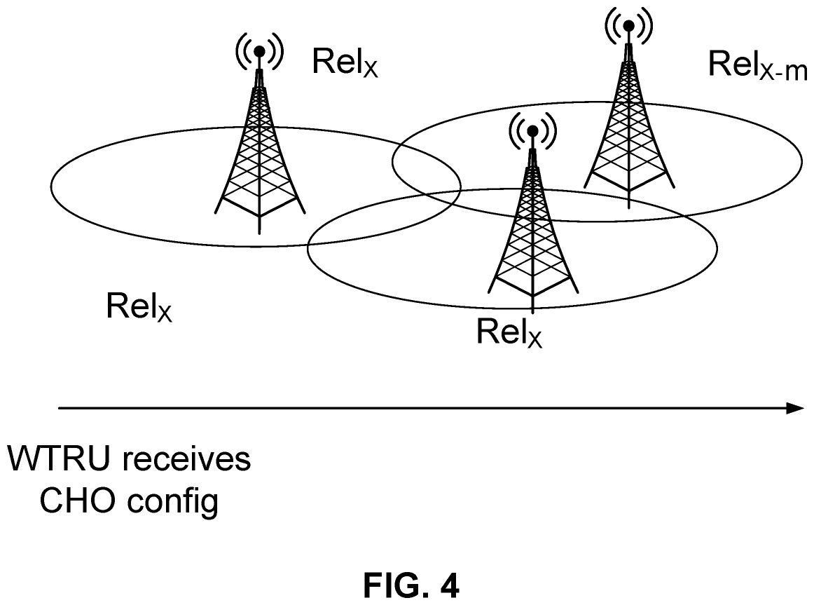

FIG. 4 illustrates an example of a WTRU receiving a CHO configuration. A WTRU may implement a particular version or release of a technology (e.g., Relx, such as Relx of the 3GPP specification, that is being served by a Relx base station). The WTRU may be configured with features or functionalities that are available in Relx, but may not have been available before Relx (e.g., introduced in Relx but not available before). The WTRU context while operating in this cell (e.g., network node) may be referred to Context_x (e.g., the configurations (e.g., all the configurations) of the WTRU bearer, security configuration, measurement configuration, WTRU state variables, etc.).

If an HO is performed, the source network node base station may send the WTRU context to the target network node in a HO request message. The target network node may decide whether to admit the WTRU or not (and if so, other aspects such as which bearers can be admitted, which WTRU parameters/features have to adjusted/changed, etc.). If the WTRU can be admitted, the target network node may send an HO request acknowledge response to the source network node. The HO request acknowledge message may include the HO command (e.g., which may be an RRC reconfiguration message that the WTRU has to apply to execute the HO).

If the target network node base station is implementing earlier technology (e.g., an earlier release) as compared to the source network node, then it may not be possible to send the complete WTRU context information that was used in the source network node to the target network node (e.g., the target network node may not be able to understand some of the content, which may result in the HO being rejected). This may be addressed via one or more of the following.

A: the source network node may first send a reconfiguration message to the WTRU to convert the WTRU context to a version compatible to the release that the target network node supports (e.g., release new types of bearers that are not supported by the target network node such as multicast bearers, release features/configurations that are not compatible with the target's release, etc.). The source network node may send the HO request message to the target network node including the updated configuration that the network understands.

B: the source network node may not need to reconfigure the WTRU to a version/release compatible with the target network node. The HO command may be sent to the WTRU from the target network node including an indication that a full configuration is to be applied (e.g., the WTRU may release its previous configuration (e.g., all its previous configurations) and may apply the updated configuration from the target network node, instead of applying a delta configuration that is applied on top of the current WTRU configuration).

The full configuration example (e.g., option B above) may result in unnecessary signaling as compared to a delta signaling. Reconfiguring the WTRU first to a version/release that is compatible with the target network node base station may lead to late HOs and HO failures (e.g., since extra round-trip time may be required to configure the WTRU before the HO command can be sent to the WTRU).

This may be exacerbated in the case of a CHO. For some scenarios (e.g., the scenario depicted in FIG. 4), if the WTRU is to be configured with a CHO towards the two target network node base stations, one base station supporting the updated version/release (e.g., the same release as the source network node base station) and another one associated with an earlier version/release, then at the time of the CHO configuration, the WTRU may (e.g., may need to) be reconfigured to a version/release compatible with an earlier version/release before the CHO configuration can be received.

This may result in one or more of the following: from the time the CHO configuration is received, the WTRU may not be able to use/benefit from the features available in the updated technology (e.g., updated version/release); previous CHO configurations towards a target network node base station of the same version/release as the source network node may (e.g., may have to) be released and reconfigured to comply with the WTRU context that is now updated to be compatible to the earlier release. If the WTRU ends up performing a CHO to a target network node that is implementing the same release as the source network node, then additional signaling may be required after the WTRU has been handed over to the target network node to bring the WTRU's context/configuration to be able to use the updated features available in the version/release that the source network node and this target network node support.

Examples are provided herein for CHO enhancements to support different specification versions/releases or implemented/supported features of candidate target cells/network node. The terms target cell and target network node may be used interchangeably.

In the descriptions herein, examples may be provided for target network nodes that may support different releases of the specification (e.g., one target supporting NR rel-16, another supporting NR rel-18,source supporting NR rel-18, etc.,). The mechanisms may be equally applicable to scenarios where the target network node may be implementing the same specification release as the source network node, but it may have one or more different capabilities than the source network node (e.g. supports a lower order MIMO, supports only a limited number of measurement configuration, etc.,) or the target network node may not have implemented some optional features of a certain release (e.g. a certain release of NR specification may have n features, of which m are optional, and one vendor may implement only the mandatory ones while another implements all the features, etc.).

Examples are provided herein of enhanced CHO configuration(s) that may include an RRC reconfiguration (e.g., an extra RRC configuration) to be applied before the HO command. A WTRU may be configured with a CHO configuration that includes an RRC reconfiguration (e.g., an additional RRC reconfiguration) that the WTRU applies before executing the HO command associated with the CHO.

The WTRU may be configured with one or more of the following configurations. CHO configuration 1: a first CHO (e.g., a legacy CHO) (e.g., trigger condition(s) and the HO command is to be executed if the CHO trigger condition(s) are fulfilled); or CHO configuration 2: trigger condition(s), a first RRC reconfiguration message to be applied if the trigger condition(s) are fulfilled, and the HO command to be executed if the first RRC reconfiguration message has been applied).

The first CHO configuration may be related to a target network node (e.g., first target network node) that supports the same version/release (or features) as the source network node, while the second (e.g., enhanced) CHO configuration may be related to a target network node (e.g., second network node) that does not support the same version/release as the source network node (e.g., or does not support all the features that the source network node supports). The WTRU may not (e.g., may not need to) be concerned about the features/releases of the source and target network node base stations, and it may simply apply the first RRC reconfiguration message that is included in the second (e.g., enhanced) CHO configuration in case the trigger condition(s) toward the second target network node are fulfilled (e.g., before executing the associated HO command). This reconfiguration (e.g., extra reconfiguration) may convert the WTRU context/configuration to a version/format compatible to that of the second target network node, and as such, the associated HO command that is executed afterwards could be a delta configuration rather than a full configuration.

Several second (e.g., enhanced) CHO configurations may share the same first RRC reconfiguration (e.g., if there are several targets of an earlier release), instead of repeating the same first RRC reconfiguration in the enhanced CHO configuration concerning each target network node. For example, the WTRU may be configured with RRC reconfiguration_1 with ID1 and RRC reconfiguration_2with ID2. The WTRU may receive second (e.g., enhanced) CHO reconfigurations A and B, that include ID1,and second (e.g., enhanced) CHO reconfigurations C and D, that include ID2. If the trigger condition(s) for CHO configuration A or B are fulfilled, the WTRU may apply RRC reconfiguration_1 first before executing the HO command associated with A or B. If the trigger condition(s) for CHO configuration C or D are fulfilled, the WTRU may apply RRC reconfiguration_2 first before executing the HO command associated with C or D.

Examples are provided herein of enhanced CHO configurations that include an RRC reconfiguration (e.g., extra RRC reconfiguration) to be applied after the HO command. A WTRU may be configured with a CHO configuration that includes an RRC reconfiguration (e.g., an additional RRC reconfiguration) that it may apply after the HO command associated with the CHO is executed.

The WTRU may be configured with one or more of the following configurations. CHO configuration 1: a first CHO (e.g., a legacy CHO) (e.g., trigger condition(s) and the HO command to be executed upon the fulfillment of the CHO trigger condition(s)).

CHO configuration 2: trigger condition(s), the HO command to be executed when the trigger condition(s) are fulfilled, an RRC reconfiguration message (e.g., an additional RRC reconfiguration message) that the WTRU applies after the HO (e.g., immediately after the HO).

The WTRU may have been reconfigured (e.g., before the CHO configuration is received), to a version/context compatible with a target network node that supports only an older version/release of the specification. As such, CHO configuration 2 may be related to a target network node that supports the same release (or features) as the source network node, while the CHO configuration 1 may be related to a target network node that does not support the same version/release as the source network node (or does not support all the features that the source network node supports). The reconfiguration message (e.g., extra reconfiguration message) that is included in CHO configuration 2 may enable a WTRU to enable the features that the target network node supports, thus enabling the WTRU to use the updated features immediately after the HO (e.g., instead of sending an extra reconfiguration message after HO to enable the features the target network node supports). These examples may (e.g., may also) apply for a normal HO.

Examples of security aspects are provided herein. The WTRU may apply a first security context (e.g., deciphering and integrity verification keys) for the first RRC message included in the second (e.g., enhanced) CHO configuration, and a second security context for the HO command included in the second (e.g., enhanced) CHO configuration. The first security context may be the security context that was being used before the trigger condition(s) were fulfilled, while the second security context could be a security context that was derived based on the first security context and information included/received in the CHO configuration.

Examples of priority aspects are provided herein. The WTRU may be configured to prioritize CHO configurations that may include the extra RRC configuration (e.g., proposed in the above examples) as compared with CHO configuration that may not include the extra RRC reconfiguration. In examples, if the trigger condition(s) towards multiple target network nodes (e.g., two target network nodes) are fulfilled at the same time, such prioritization may help the WTRU being handed over to a target network node that supports features that were supported by the source network node (e.g., all the features that were supported by the source network node).

The WTRU may be configured with a margin of prioritization of first CHOs (e.g., legacy CHOs) as compared to second CHOs (e.g., enhanced CHOs). For example, assume the WTRU is configured with CHO towards target network node 1 (e.g., first/legacy CHO) and target network node 2 (e.g., second/enhanced CHO). If the trigger condition(s) towards both target network nodes are fulfilled, the WTRU may be configured to compare the radio quality of the two target network nodes and prioritize the CHO towards the first target network node unless the radio quality of the second target network node is better than the first target network node by more than a configured threshold.

Examples of generalizations in cases of multiple target network nodes associated with multiple releases are provided herein. In examples, there may be multiple target network nodes that have different releases/features. For example, the source network node and target network node 1 may support release x, target network node 2 may support release x−1, target network node 3 may supports release x−2, and so on. In such cases, from the WTRU perspective, the second configuration (e.g., enhanced CHO configuration) concerning target network node 2 and target network node 3 may look the same (e.g., including an extra RRC reconfiguration and the HO command). However, it may be desirable to prioritize target network node 2 over target network node 3 (e.g., as it may support more features).

An explicit priority level may be included in second (e.g., enhanced) CHO configuration(s) that include the extra RRC reconfiguration. This may help (e.g., may implicitly help) the WTRU hand over to the target network node that supports the most/latest features. In examples, the CHO configuration towards target network node 2 may include a priority level that is higher than the CHO configuration towards target network node 3, so that if the trigger condition(s) towards both target network nodes are fulfilled, the WTRU may apply the configurations associated with target network node 2. The priority information may be included inside the CHO configurations, or the WTRU may be provided with a separate priority list that indicates the priority levels of the different target network nodes (or different CHO configurations).

Examples are provided herein of separate trigger condition(s) for the extra RRC reconfiguration message. Separate trigger condition(s) may be configured for the extra RRC reconfiguration as compared to the HO command included in the second (e.g., enhanced) CHO configuration. The first RRC reconfiguration may be applied if first trigger condition(s) are fulfilled, and the WTRU may keep monitoring the radio conditions until the second trigger condition(s) are fulfilled. If the first RRC reconfiguration is applied due to the fulfillment of the first trigger condition(s), the WTRU may release/delete other configurations (e.g., all the other CHO configurations) except for the configuration that includes the executed RRC reconfiguration (e.g., as the current WTRU context after the application of this RRC reconfiguration may invalidate all the other CHO configurations). If the first RRC reconfiguration is applied due to the fulfillment of the first trigger condition(s), the WTRU may keep the other CHO configurations that also have additional RRC reconfiguration (e.g., as the first RRC reconfiguration in these CHO configurations may be performing the same role as the RRC reconfiguration just executed (e.g., (converting the WTRU context to a version/release compatible to an earlier specification version/release). The WTRU (e.g., in these cases) may not remove/ignore the first RRC reconfiguration message included in these second (e.g., enhanced) CHO configurations that are kept.

Examples are provided herein of the handling of the complete message regarding the first reconfiguration message. In a legacy operation, the WTRU may respond to the network node/cell that sent the RRC message with a reconfiguration complete message (e.g., after executing an RRC reconfiguration message). This may ensure that the same WTRU context is kept at the WTRU and the network (e.g., until the network receives the complete message, it may assume the WTRU to have the context before the reconfiguration message was sent). The WTRU may send the reconfiguration complete message regarding the first RRC reconfiguration message to the source cell/network node after (e.g., immediately after) the successful application of the first RRC reconfiguration message. The WTRU may send the reconfiguration complete message regarding the first RRC reconfiguration message by embedding it inside the reconfiguration complete message regarding the HO command from the target network node (e.g., as the HO command that is executed after the first reconfiguration message also results in a complete message, but this one to be sent to the target network node). The target network node may forward (e.g., transparently forward) this complete message to the source network node. The WTRU may refrain from sending the reconfiguration complete message regarding the first RRC reconfiguration message if the HO command towards the target network node is executed properly (e.g., the reception of the complete message regarding the HO command associated with the CHO may be an implicit signal to the network that the first reconfiguration message was executed successfully as well).

The examples provided herein may (e.g., may also) be applicable in the case of CPC (e.g., when there is a difference in release/capability/supported features between the source secondary network node and the target secondary network node). The second (e.g., enhanced) CPC configuration may include an extra RRC reconfiguration (SCG change command) that the WTRU may apply in case the CPC condition(s) are fulfilled (e.g., before actually executing the associated secondary cell change command). This RRC reconfiguration (e.g., additional RRC reconfiguration) may be a delta configuration on the current SCG configuration and if the WTRU applies it (e.g., if the trigger conditions for the CPC are fulfilled), the WTRU's SCG configuration may be converted to a configuration that is compatible with the target network node configuration. As such, the associated SCG change command with a delta configuration that has been generated from the target network node (e.g., or negotiated between the source network node and the target network node) may be directly applied on top of this configuration. This way, the WTRU may operate with an SCG configuration that is of an updated version/release (e.g., or has additional features) as compared to what the target network node SCG is able to support, even after the configuration of a CPC, until the CPAC trigger conditions are fulfilled, without the need to have a full SCG reconfiguration during SCG change.

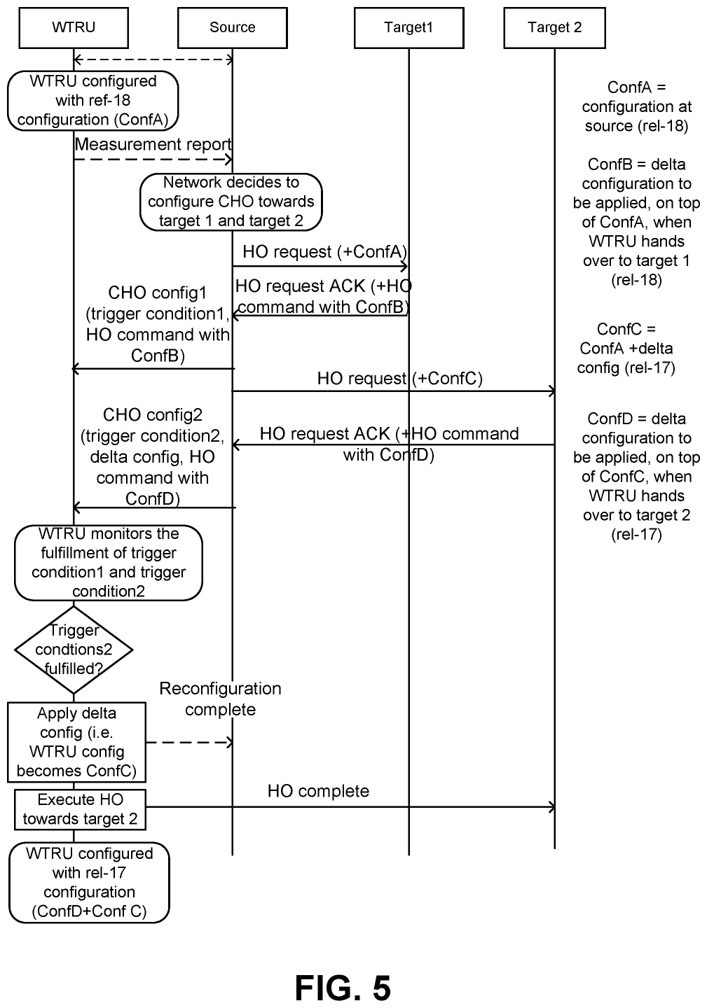

FIG. 5 illustrates an example of a WTRU configured with a CHO configuration between a source node and two target network nodes. The two target network nodes may include one target network node associated with a first configuration that includes the same version/release (e.g., a later version/release, such as later communications standards version or a later 3GPP standard release) as the source network node (e.g., target 1), and another target network node (e.g., target 2) associated with a second configuration (e.g., that is of an earlier version/release, such as an earlier communications standards version or an earlier 3GPP standard release). CHO configuration information (e.g., applied to the HO to the second target network node) received by the WTRU may include trigger condition(s), a HO command, and an additional RRC reconfiguration (e.g., delta configuration). If the WTRU determines the CHO trigger condition(s) for the second target network node are fulfilled, it may apply the delta configuration first. The delta configuration may change at least a part of first configuration (e.g., to align the WTRU context) to be compatible with at least a feature of the second target network node (e.g., an earlier version/release compatible to that of the second target network node). In examples, the delta configuration may change a part of the first configuration to be compatible with a feature of the second target network node and not change a part (e.g., a remainder) of the first configuration. The WTRU may (e.g., may then, after the delta configuration is applied) apply (e.g., execute) the associated HO command (e.g., to the second target network node) without any version/format issue. In examples, before the HO command is applied and after the delta configuration is applied, the WTRU may communicate with the source network node using the first configuration (e.g., the source network node is compatible with the first WTRU configuration and not compatible with the second WTRU configuration). The WTRU may send an indication (e.g., via an RRC reconfiguration complete message embedded in an HO complete message) to the second network node that indicates the HO command the delta configuration have been applied.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A wireless transmit/receive unit (WTRU), comprising:
a processor configured to:
communicate with a source network node in accordance with a first configuration;
receive conditional handover (CHO) configuration information, wherein the CHO configuration information includes a trigger condition, a handover (HO) command, and a delta configuration;
based on a determination that the trigger condition is fulfilled, apply the delta configuration;
after the delta configuration is applied, execute the HO command; and
send an indication that indicates the HO command and the delta configuration have been applied.

20. The WTRU of claim 19, wherein the application of the delta configuration changes the first configuration of the WTRU to be compatible with a target network node.

21. The WTRU of claim 20, wherein the changed configuration of the WTRU that is compatible with the target network node supports less capabilities than the first configuration.

22. The WTRU of claim 20, wherein the changed configuration of the WTRU that is compatible with the target network node is compatible with a communications standard version associated with the target network node, and wherein the communication standard version associated with the target network node is an earlier communications standard version than a communications standard version associated with the source network node.

23. The WTRU of claim 22, wherein the communications standard version associated with the target network node is an earlier 3GPP standard release and the communications standard version associated with the source network node is a later 3GPP standard release.

24. The WTRU of claim 19, wherein the trigger condition is fulfilled if a reference signal received power (RSRP) or reference signal received quality (RSRQ) measurement of a target network node meets a threshold, an RSRP or RSRQ measurement of the source network node meets a threshold, a comparison between measurements of the target network node and measurements of the source network node meet a threshold, or a set of radio conditions are fulfilled.

25. The WTRU of claim 19, wherein the processor is configured to further communicate with the source network node after the delta configuration is applied and before the HO command is applied.

26. The WTRU of claim 25, wherein the processor being configured to further communicate with the source network node comprises communication using a feature supported by the first configuration associated with the source network node that is not supported by a second configuration associated with a target network node.

27. The WTRU of claim 19, wherein the indication is comprised in a radio resource control (RRC) reconfiguration complete message embedded in an HO complete message sent towards a target network node.

28. A method implemented in a wireless transmit/receive unit (WTRU), comprising:
communicating with a source network node in accordance with a first configuration;
receiving conditional handover (CHO) configuration information, wherein the CHO configuration information includes a trigger condition, a handover (HO) command, and a delta configuration;
based on a determination that the trigger condition is fulfilled, applying the delta configuration;
after the delta configuration is applied, executing the HO command; and
sending an indication that indicates the HO command and the delta configuration have been applied.

29. The method of claim 28, wherein the application of the delta configuration changes the first configuration of the WTRU to be compatible with a target network node.

30. The method of claim 29, wherein the changed configuration of the WTRU that is compatible with the target network node supports less capabilities than the first configuration.

31. The method of claim 29, wherein the changed configuration of the WTRU that is compatible with the target network node is compatible with a communications standard version associated with the target network node, and wherein the communication standard version associated with the target network node is an earlier communications standard version than a communications standard version associated with the source network node.

32. The method of claim 31, wherein the communications standard version associated with the target network node is an earlier 3GPP standard release and the communications standard version associated with the source network node is a later 3GPP standard release.

33. The method of claim 28, wherein the trigger condition is fulfilled if a reference signal received power (RSRP) or reference signal received quality (RSRQ) measurement of a target network node meets a threshold, an RSRP or RSRQ measurement of the source network node meets a threshold, a comparison between measurements of the target network node and measurements of the source network node meet a threshold, or a set of radio conditions are fulfilled.

34. The method of claim 28, wherein the method is configured to further communicate with the source network node after the delta configuration is applied and before the HO command is applied.

35. The method of claim 34, wherein the method configured to further communicate with the source network node comprises communication using a feature supported by the first configuration associated with the source network node that is not supported by a second configuration associated with a target network node.

36. The method of claim 28, wherein the indication is comprised in a radio resource control (RRC) reconfiguration complete message embedded in an HO complete message sent towards a target network node.
